(19) United States
(12) Patent Application Publication
(10) Pub. No.: US 2023/0325463 A1
(43) Pub. Date: Oct. 12, 2023

(54) INFORMATION PROCESSING DEVICE, CONTROL METHOD AND STORAGE MEDIUM

(71) Applicant: NEC CORPORATION, Minato-ku Tokyo (JP)

(72) Inventors: Tatsuya MATSUOKA, Tokyo (JP); Naoto OHSAKA, Tokyo (JP)

(73) Assignee: NEC CORPORATION, Minato-ku Tokyo (JP)

(21) Appl. No.: 18/024,940

(22) PCT Filed: Sep. 14, 2020
(86) PCT No.: PCT/JP2020/034671

§ 371 Date: Mar. 6, 2023

(51) Int. Cl. G06F 17/16; G06F 17/18

(52) U.S. Cl. CPC G06F 17/16; G06F 17/18

(57) ABSTRACT

The information processing device 1X mainly includes an acquisition means 5X and a generation means 6X. The acquisition means 5X is configured to acquire principal minor determinants of a first Hermitian matrix, the first Hermitian matrix representing a probability distribution regarding selection of a subset from a set of a predetermined number of elements. The generation means 6X is configured to generate, based on the principal minor determinants, a second Hermitian matrix which is consistent with the first Hermitian matrix with respect to all principal minor determinants.

### TECHNICAL FIELD

The present disclosure relates to the technical field of an information processing device, a control method, and a storage medium relating to learning of a probability distribution.

### BACKGROUND ART

There is known a technique called a determinantal point process which expresses, as a matrix, a probability distribution on subsets of a underlying set. Even in such a case that the number of possible subsets of a set with n elements is 2ⁿ and therefore O(2ⁿ) parameters are required to express an arbitrary distribution, it is possible to express the probability distribution with a certain property by using O(n²) parameters according to the determinantal point process. Non-Patent Literature 1 discloses a method of learning a symmetric matrix based on a principal minor determinant, and discloses, as an application, the learning of the probability distribution corresponding to a symmetric matrix (belonging to some class) having a certain property.

### CITATION LIST

### Non-Patent Literature

Non-Patent Literature 1: J. Rising, A. Kulesza, and B. Taskar. An efficient algorithm for the symmetric principal minor assignment problem. Linear Algebra and its Applications, 473, pp. 126-144, 2015.

### SUMMARY

### Problem to be Solved

Non-Patent Literature 1 is silent on the learning of the probability distribution corresponding to the asymmetric matrix. In view of the above-described issues, it is an object of the present disclosure to provide an information processing device, a control method, and a storage medium capable of suitably learning a probability distribution.

### Means for Solving the Problem

In one mode of the control device, there is provided a control device including:
an acquisition means configured to acquire principal minor determinants of a first Hermitian matrix, the first Hermitian matrix representing a probability distribution regarding selection of a subset from a set of a predetermined number of elements; and
a generation means configured to generate, based on the principal minor determinants, a second Hermitian matrix which is consistent with the first Hermitian matrix with respect to all principal minor determinants.

In one mode of the control method, there is provided a control method executed by a computer, the control method including:
acquiring principal minor determinants of a first Hermitian matrix, the first Hermitian matrix representing a probability distribution regarding selection of a subset from a set of a predetermined number of elements; and
generating, based on the principal minor determinants, a second Hermitian matrix which is consistent with the first Hermitian matrix with respect to all principal minor determinants.

In one mode of the storage medium, there is provided a storage medium storing a program executed by a computer, the program causing the computer to function as:
acquire principal minor determinants of a first Hermitian matrix, the first Hermitian matrix representing a probability distribution regarding selection of a subset from a set of a predetermined number of elements; and
generate, based on the principal minor determinants, a second Hermitian matrix which is consistent with the first Hermitian matrix with respect to all principal minor determinants.

### Effect

An example advantage according to the present invention is to suitably learn a probability distribution.

### BRIEF DESCRIPTION OF THE DRAWINGS

FIG. 1 illustrates the configuration of a learning system according to a first example embodiment.

FIG. 2 illustrates an outline of the process in the first example embodiment.

FIG. 3 illustrates a matrix of a probability distribution based on determinantal point processes.

FIG. 4 illustrates an example of a hardware configuration of an information processing device in the first example embodiment and a second example embodiment in common.

FIG. 5 illustrates an example of a flowchart showing the procedure of the generation process of the second Hermitian matrix in the first example embodiment and a second example embodiment in common.

FIG. 6 illustrates an example of a flowchart showing the procedure of the directed branch pair adding process.

FIG. 7 illustrates an example of a supplementary graph generated at step S12 in FIG. 5.

FIG. 8 illustrates a supplementary graph after the execution of the process at step S14 in FIG. 5.

FIG. 9 illustrates a supplementary graph after the execution of the process at step S15 in FIG. 5.

FIG. 10 is an example of a functional block diagram of the information processing device according to the second example embodiment.

FIG. 11 is a functional block diagram of the information processing device according to a third example embodiment.

FIG. 12 illustrates an example of a flowchart executed by the information processing device in the third example embodiment.

### EXAMPLE EMBODIMENTS

Hereinafter, example embodiments of an information processing device, a control method, and a storage medium will be described with reference to the drawings.

### First Example Embodiment

(1) System Configuration

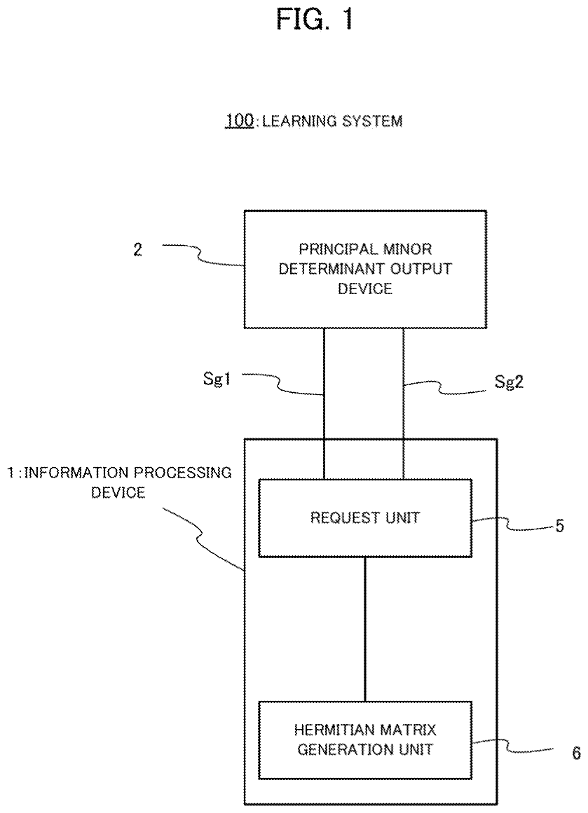

FIG. 1 shows a configuration of a learning system 100 according to the first example embodiment. The learning system 100 is a system which efficiently performs learning of a Hermitian matrix representing a probability distribution, in a situation where a subset of a given set is selected, through allocation of principal minor determinants regarding the probability distribution corresponding to the Hermitian matrix. The learning system 100 mainly includes an information processing device 1 and a principal minor determinant output device 2. Hereafter, a given set (underlying set) is denoted as “V”, and a subset of the set V is denoted as “S”.

The information processing device 1 learns a probability distribution from partial information (i.e., principal minor determinants) on the assumption that the probability distribution to be estimated is according to a determinantal point process (DPP: Determinantal Point Process) of a Hermitian matrix. Here, the determinantal point process expresses, as a n×n matrix, the probability distribution for the subset of the underlying set with size “n”, wherein the probability of selecting a subset S from the underlying set V is determined according to an expression including the determinant of the submatrix corresponding to the subset S. Every principal minor determinant of the matrix according to the determinantal point process becomes nonnegative. Then, the information processing device 1 performs learning of the probability distribution through construction of a matrix (construction of a Hermitian matrix in the present example embodiment).

The information processing device 1 functionally includes a request unit 5 and a Hermitian matrix generation unit 6.

The request unit 5 transmits a query “Sg1” specifying a subset S to the principal minor determinant output device 2 and receives the principal minor determinant information “Sg2” representing the principal minor determinant corresponding to the subset S specified by the query Sg1 from the principal minor determinant output device 2 as a response to the query Sg1. The Hermitian matrix generation unit 6 generates a Hermitian matrix representing a probability distribution to be estimated based on the principal minor determinant information Sg2 which the request unit 5 has received from the principal minor determinant outputting device 2. Details of the process to be executed by the Hermitian matrix generation unit 6 will be described later.

When the principal minor determinant output device 2 receives the query Sg1 from the information processing device 1, the principal minor determinant output device 2 generates principal minor determinant information Sg2 indicating a principal minor determinant corresponding to the subset S specified by the query Sg1, and transmits the principal minor determinant information Sg2 to the information processing device 1.

(2) Process Overview

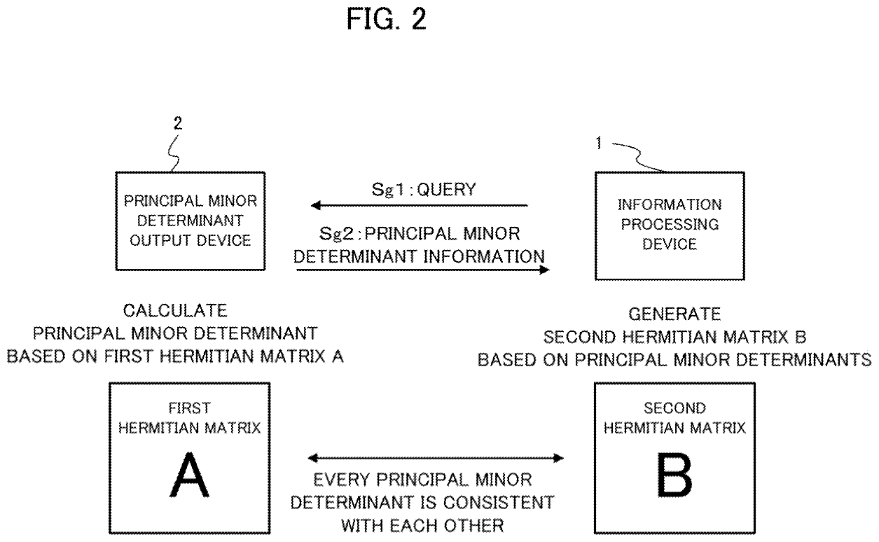

FIG. 2 is a diagram showing an outline of the processes executed by the information processing device 1 and the principal minor determinant output device 2. Hereafter, a Hermitian matrix representing the probability distribution to be estimated is denoted as “first Hermitian matrix A”, and a Hermitian matrix generated by the information processing device 1 by learning is denoted as “second Hermitian matrix B”.

As shown in FIG. 2, the information processing device 1 transmits the query Sg1 specifying the subset S corresponding to the principal minor determinant required for generating the second Hermitian matrix B to the principal minor determinant output device 2. In this instance, the principal minor determinant output device 2 generates the principal minor determinant information Sg2 representing the principal minor determinant of the first Hermitian matrix A corresponding to the specified subset S and transmits the generated principal minor determinant information Sg2 to the information processing device 1.

Then, based on the principal minor determinant information Sg2, the information processing device 1 generates a second Hermitian matrix B such that every principal minor determinant of the first Hermitian matrix A and the second Hermitian matrix B are consistent with each other. In the determinantal point process, the probability distribution is determined depending on the principal minor determinants. Therefore, the information processing device 1 generates such a second Hermitian matrix B which is consistent with the second Hermitian matrix B with respect to all principal minor determinants. Thereby, the information processing device 1 can generate a second Hermitian matrix B representing the same probability distribution as the probability distribution corresponding to the first Hermitian matrix A.

Here, a supplementary explanation will be given of the determinantal point process. According to the determinantal point process, the probability distribution of 2ⁿ subsets based on n elements can be represented by a “n×n” matrix when the probability distributions have a certain property. Then, in the determinantal point process, the determinant calculated from the components of the above-mentioned matrix corresponding to elements constituting the subset corresponds to the probability that the subset is sampled. Then, according to the determinantal point process, the degree of ease (selection easiness) of selection of each element is represented by diagonal components of the matrix while the difficulty of compatibility between elements (difficulty of simultaneously selecting elements) is represented by off-diagonal components of the matrix.

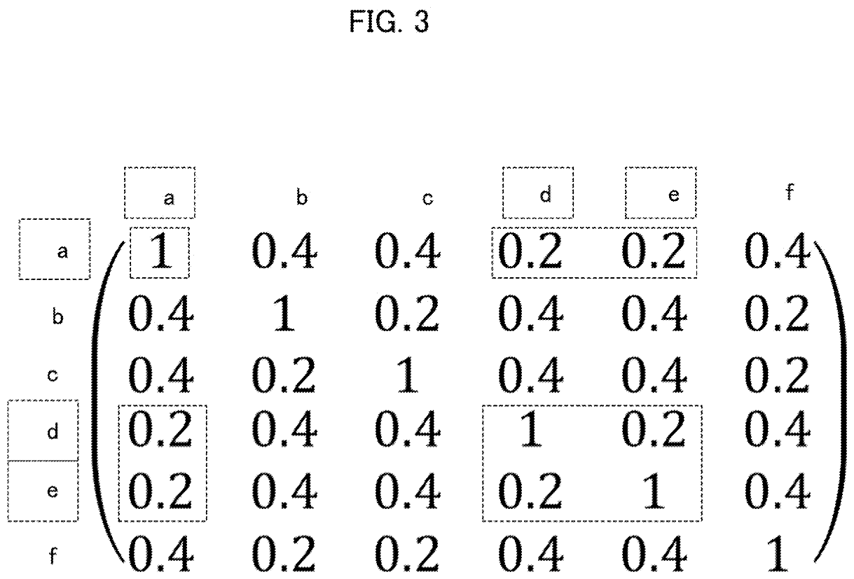

FIG. 3 shows a matrix of the probability distribution based on the determinantal point process for the six elements (“a” to “f”) constituting the set V. In FIG. 3, the first column and the first row correspond to the element a, the second column and the second row correspond to the element b, and the third column and the third row correspond to the element c. Further, the fourth column and the fourth row correspond to the element d, the fifth column and the fifth row corresponds to the element e, the sixth column and the sixth row corresponds to the element f.

Here, as an example, the probability of a subset S of elements a, d, and e is considered. In this case, the probability of the subset S of the elements a, d, and e is obtained by dividing the 3×3 principal minor determinant configured by the matrix components in the dashed-line frames associated with the elements a, d, and e by the sum of the 3×3 principal minor determinants corresponding to all 20 (=₆C₃) combinations of three elements selected from all six elements.

(3) Hardware Configuration

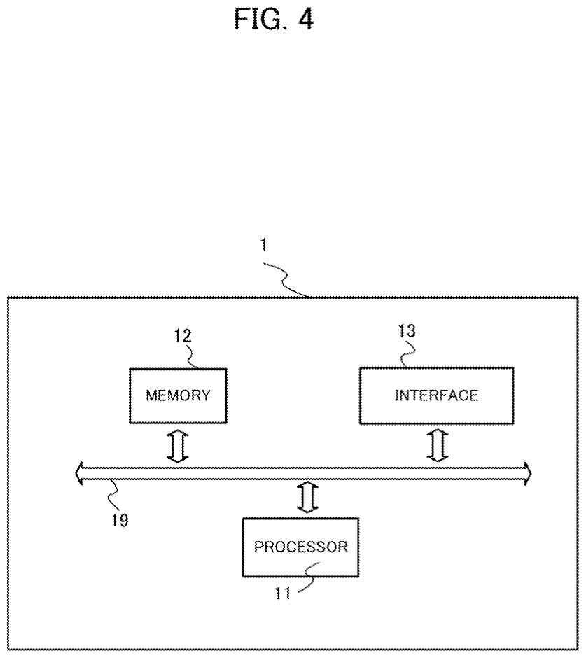

FIG. 4 shows an example of a hardware configuration of the information processing device 1. The information processing device 1 includes a processor 11, a memory 12, and an interface 13 as hardware. The processor 11, memory 12, and interface 13 are connected to one another via a data bus 19.

The processor 11 functions as a controller (arithmetic unit) configured to control the entire information processing unit 1 by executing a program stored in the memory 12. Examples of the processor 11 include a CPU (Central Processing Unit), a GPU (Graphics Processing Unit), and a TPU (Tensor Processing Unit). The processor 11 may be configured by a plurality of processors. The processor 11 is an example of a computer.

The memory 12 includes a variety of volatile and non-volatile memories, such as a RAM (Random Access Memory), a ROM (Read Only Memory), and a flash memory. Further, a program to be executed by the information processing device 1 is stored in the memory 12. A part of the information stored in the memory 12 may be stored by one or more external storage devices configured to communicate with the information processing device 1, or may be stored by a storage medium detachable from the information processing device 1.

The interface 13 is one or more interfaces for electrically connecting the information processing device 1 to another device. Examples of the interfaces include a wireless interface, such as a network adapter, for wirelessly transmitting and receiving data to and from other devices, and a hardware interface, such as a cable, for connecting to other devices.

Here, a description will be given of the relation between the request unit 5 and the Hermitian matrix generation unit 6 of the information processing device 1 shown in FIG. 1 and the hardware configuration shown in FIG. 4. Each component of the request unit 5 and the Hermitian matrix generation unit 6 can be realized, for example, by the processor 11 executing a program. In this case, a necessary program may be recorded on any non-volatile storage medium and installed as necessary to realize each component. When the processor 11 functions as the request unit 5, the processor 11 exchanges the query Sg1 and the principal minor determinant information Sg2 via the interface 13 with the principal minor determinant output device 2.

At least a portion of the request unit 5 and the Hermitian matrix generation unit 6 may be realized by any combination of hardware, firmware, and software or the like without being limited to being implemented by software based on a program. At least some of these components may also be implemented using a user programmable integrated cycle such as, for example, a FPGA (Field-Programmable Gate Array) or a microcontroller. In this case, the integrated cycle may be used to realize a program to function as each of the above components. Further, at least a portion of the components may be constituted by an ASSP (Application Specific Standard Produce), a ASIC (Application Specific Integrated Cycle), or a quantum processor (quantum computer control chip). Thus, each component may be implemented by various hardware. The above explanation is true for other example embodiments described later. Furthermore, each of these components may be implemented by the cooperation of a plurality of computers, for example, using cloud computing technology.

(4) Generation of Second Hermitian Matrix B

Next, a specific description will be given of a method of generating the second Hermitian matrix B by the Hermitian matrix generation unit 6. Schematically, the Hermitian matrix generation unit 6 forms a spanning tree in a supplementary graph with n vertices on the basis of all 1×1 and 2×2 principal minor determinants obtained by the request unit 5 from the principal minor determinant output device 2, and determines components of the second Hermitian matrix B corresponding to the weights for branches of the spanning tree to be real values. In addition, the Hermitian matrix generation unit 6 sequentially determines the weight for a pair of branches (a pair of directed branches whose start and end points are reversed) corresponding to each undetermined non-zero component of the second Hermitian matrix B.

(4-1) Processing Flow

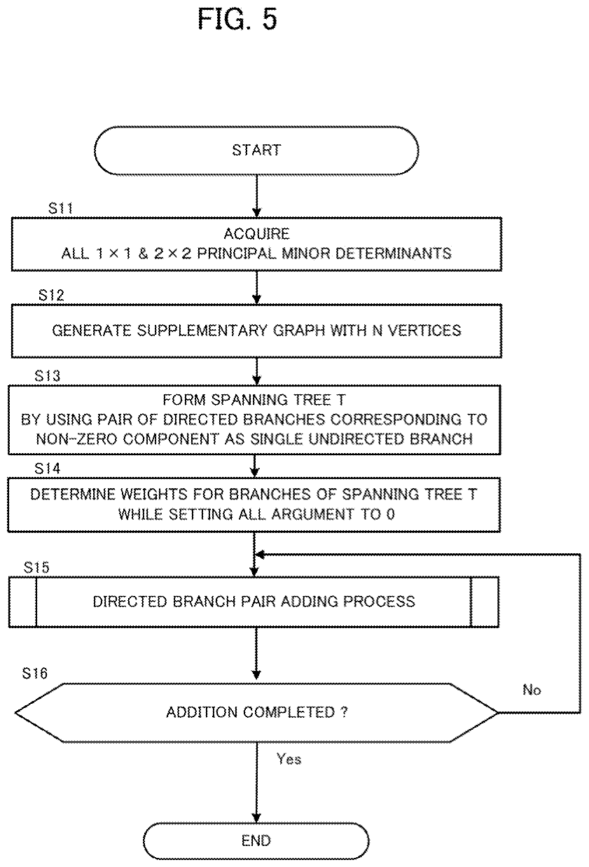

FIG. 5 is an example of a flowchart illustrating a procedure of a generation process of the second Hermitian matrix B.

First, the request unit 5 obtains all possible 1×1 principal minor determinants and 2×2 principal minor determinants (step S11). In this case, the request unit 5 acquires, from the principal minor determinant output device 2, principal minor determinants corresponding to all possible combinations (i.e., n+ₙC₂ combinations) of one or two elements selected from n elements in the set V. In this instance, the request unit 5 transmits the query Sg1 to the principal minor determinant output device 2, and receives the principal minor determinant information Sg2 representing the above-described principal minor determinants from the principal minor determinant output device 2.

Here, “Bⱼₖ” denotes the component of the second Hermitian matrix B in the “j”th row and “k”th column (j and k are integers equal to or larger than 1 and equal to or smaller than n, and j<k), “θⱼₖ” denotes an argument (declination) of the above-mentioned component, and “A (S)” denotes a principal minor determinant of the first Hermitian matrix A corresponding to the subset S. In this instance, the request unit 5 acquires the following principal minor determinants at step S11.

Bⱼⱼ=det(A({j}))

Bⱼₖ={square root over (det(A({j}))det(A({k}))−det(A({j,k})))}e^{iθ}^{ⱼₖ}(j<k)

Bₖⱼ={square root over (det(A({j}))det(A({k}))−det(A({j,k})))}e^{-iθ}^{ⱼₖ}(j<k)

Bₖⱼ (j<k) is uniquely determined from Bⱼₖ (j<k). Thus, in some embodiments, the request unit 5 (or Hermitian matrix generation unit 6) may determine Bₖⱼ (j<k) from Bⱼₖ (j<k) instead of obtaining Bₖⱼ (j<k) from the principal minor determinant output device 2.

Next, the Hermitian matrix generation unit 6 generates a supplementary graph with n vertices (step S12). Here, the Hermitian matrix generation unit 6 generates pairs of directed branches (j, k) and (k, j) if Bⱼₖ (j<k) is not 0. Here, the weight for each directed branch corresponds to the component of the second Hermitian matrix B corresponding to the row number and the column number specified by the combination of vertices of the start and end of the directed branch.

Then, the Hermitian matrix generation unit 6 uses a pair of directed branches corresponding to a non-zero component as a single undirected branch and forms a spanning tree “T” (i.e., a partial graph in which all vertices are connected and there is no cycle) (step S13). In this case, the Hermitian matrix generation unit 6 generates the spanning tree T by performing width breadth-first search from the vertex with the label 1, for example.

Then, the Hermitian matrix generation unit 6 determines the weights for the branches of the spanning tree T formed at step S13 while setting all argument θⱼₖ to 0 (step S14). In this instance, the Hermitian matrix generation unit 6 sets the weights for branches of the spanning tree T to real values based on the respective 1×1 principal minor determinants and 2×2 principal minor determinants acquired at step S11. Thus, the values of the components of the second Hermitian matrix B corresponding to the branches of the spanning tree T are determined.

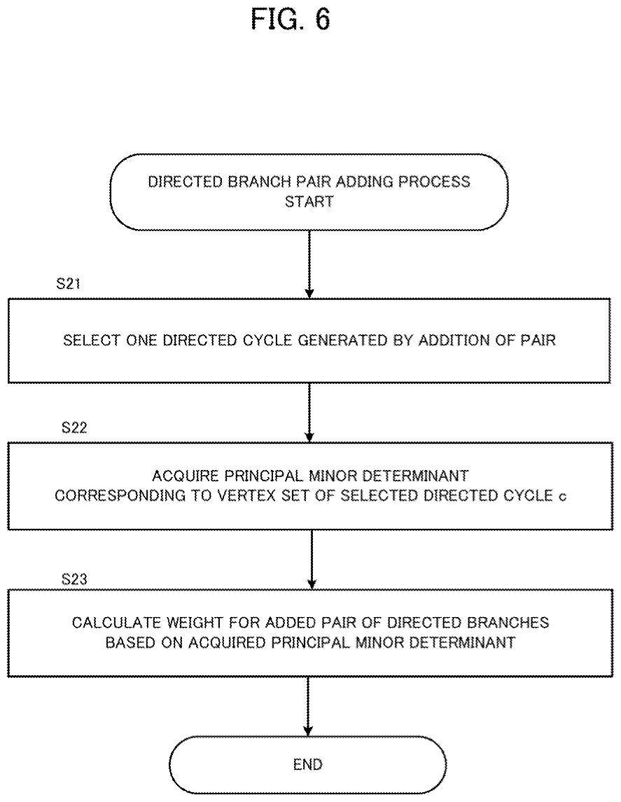

Next, the Hermitian matrix generation unit 6 performs a directed branch pair adding process, which is a process of adding a pair of directed branches that do not included in the spanning tree T (step S15). In this case, the Hermitian matrix generation unit 6 adds a pair of directed branches that is not included to the spanning tree T in the dictionary order of the depth, in the spanning tree T, at both ends of the pair. The process at step S15 will be described later with reference to FIG. 6. Then, if the Hermitian matrix generation unit 6 completes the addition of all directed branch pairs of interest (step S16; Yes), it ends the process of the flowchart. On the other hand, if the Hermitian matrix generation unit 6 has not yet completed the addition of any directed branch pair of interest (step S16; No), the Hermitian matrix generation unit 6 performs the directed branch pair adding process at step S15 for the directed branch pair to be added.

FIG. 6 is an example of a flowchart showing the steps of the directed branch pair adding process performed at step S15 in FIG. 5.

First, the Hermitian matrix generation unit 6 selects one of directed cycle(s) generated by adding a directed branch pair to the spanning tree T (step S21). Hereafter, the selected directed cycle is referred to as “c”. In this case, in the selection of the directed cycle c, the Hermitian matrix generation unit 6 selects a directed cycle without any branches forming a shortcut. Then, the request unit 5 acquires the principal minor determinant corresponding to the vertex set of the directed cycle c (step S22). In this instance, the request unit 5 transmits the query Sg1 to the principal minor determinant output device 2 to obtain the principal minor determinant information Sg2 representing the principal minor determinant corresponding to the vertex set of the directed cycle c.

Then, the Hermitian matrix generation unit 6 calculates the weight for the pair of directed branches added to the spanning tree T based on the principal minor determinant acquired at step S22 (step S23). Specifically, assuming that “M” denotes the principal minor determinant corresponding to the vertex set of the directed cycle c, the Hermitian matrix generation unit 6 calculates the weight for the directed branches added to the spanning tree T according to the following equation. It is herein assumed, to satisfy the following equation, that the directed cycle c corresponding to the principal minor determinant M has no shortcut.

det(M)=M_{n,n}det(M[1,n−1])−|M_{n-1,n}|²det(M[1,n−2])−|M_{1,n}|²det(M[2,n−1])+2(−1)ⁿ⁺¹M_{1,n}Πₗ₌₁ⁿ⁻¹M_{l,l+1}

Here, “M[p,q]” denotes the principal minor determinant corresponding to (pth to qth rows of the principal minor determinant M) and (pth to qth columns of the principal minor determinant M). Here, n denotes the number of rows in the principal minor determinant M. Here, the last term on the right-hand side of the equation above is multiplied by what corresponds to the weight for the added paired directed branches. Therefore, the Hermitian matrix generation unit 6 calculates the weight for the added paired directed branches by solving the above equation with respect to what corresponds to the weight. It is noted that the calculation method of the matrix components according to the same procedure as disclosed in Non-Patent Literature 1 can be applied for a real symmetric matrix that is a type of a Hermitian matrix. The present disclosure is different from Non-Patent Literature 1 in that the present disclosure uses a directed graph, particularly a graph in which branches forming a bidirectional pair are always present, and each pair of branches is associated with the augment which is 0 in total in the present disclosure.

(4-2) Specific Example

Next, a specific example of the calculation method of the second Hermitian matrix B described by the flowcharts shown in FIG. 5 and FIG. 6 will be described. Here, as an example, the following Hermitian matrix is defined as the first Hermitian matrix A.

$$A = ( \begin{matrix}10 & 2 {e}^{i π / 6} & 0 & {e}^{- i π / 4} \\ 2 {e}^{- i π / 6} & 12 & {e}^{- i π / 3} & 0 \\ 0 & {e}^{i π / 3} & 14 & 3 {e}^{i π / 4} \\ {e}^{i π / 4} & 0 & 3 {e}^{- i π / 4} & 16\end{matrix} )$$

Here, first, based on step S11 in FIG. 5, the request unit 5 acquires all possible 1×1 principal minor determinants and 2×2 principal minor determinants of the first Hermitian matrix A. In this case, for example, the request unit 5 acquires, as 1×1 principal minor determinants, the following four values:
Det(A ({1}))=10,
Det (A ({2}))=12,
Det (A ({3}))=14,
Det (A ({4}))=16.

Further, the request unit 5 acquires, as 2×2 principal minor determinants, six values including the following two values:
Det (A ({1, 2}))=116,
Det(A ({3, 4}))=215.

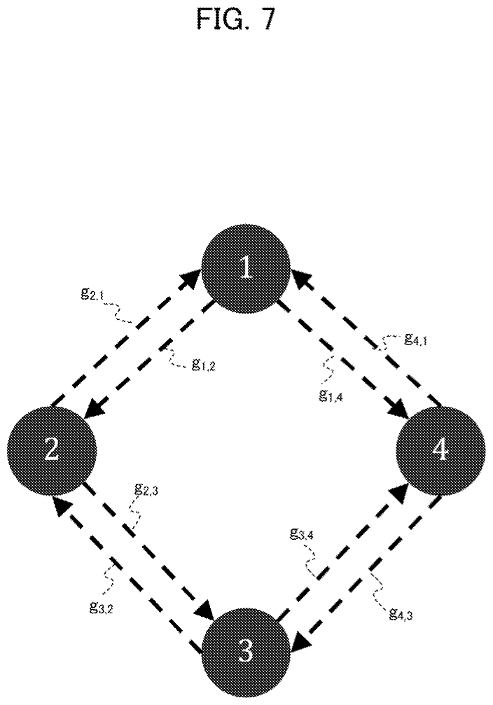

Next, the Hermitian matrix generation unit 6 generates a supplementary graph with n (four in this case) vertices based on the process at step S12. FIG. 7 shows an example of a supplementary graph generated at step S11. Here, the Hermitian matrix generation unit 6 determines that, based on the acquired principal minor determinants, the component “B₁₃” in the first row and the third column, the component “B₃₁” in the third row and the first column, the component “B₂₄” in the second row and the fourth column, and the component “B₄₂” in the fourth row and the second column are respectively 0, and that other components are non-zero components. Therefore, the Hermitian matrix generation unit 6 recognizes that any possible pairs of vertices (i.e., 1 to 2, 2 to 3, 3 to 4, and 4 to 1) corresponding to the non-zero components are targets of connection by directed branches. In the state shown in FIG. 7, directed branches starting at vertex j and ending at vertex k are denoted as “g_{j,k}”. Here, the directed branches for which the weights (i.e., the components of the corresponding second Hermitian matrix B) are determined are shown by solid lines, and the directed branches for which the weights are undetermined are shown by dashed lines. In the state shown in FIG. 7, the weights are undetermined for all directed branches.

Furthermore, on the basis of the process at step S13, the Hermitian matrix generation unit 6 forms a spanning tree by using each pair of directed branches corresponding to the non-zero components as one undirected branch, and determines the weights for the branches of the spanning tree T based on the process at step S14 while setting every argument θⱼₖ to zero.

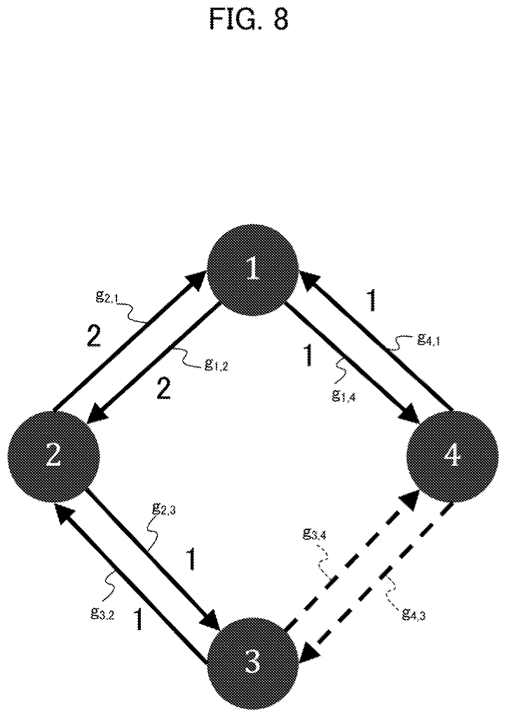

FIG. 8 shows an example of supplementary graph after the process at step S14 is performed. In FIG. 8, the directed branches for which the weights (i.e., the corresponding components of the second Hermitian matrix B) are calculated are shown by solid lines, and the calculated weights are clearly shown. Here, the Hermitian matrix generation unit 6 forms the spanning tree connecting the vertices 1 and 4, the vertices 1 and 2, and the vertices 2 and 3, and then calculates the weights for the branches of the spanning tree based on the principal minor determinants acquired at step S11 on the assumption that each argument is 0. For example, the component “B₄₁” is calculated according to the following equation.

B₄₁=B₁₄={square root over (det(A({1}))det(A({4}))−det(A({1,4})))}=\sqrt{10×16−159}=1

On the other hand, regarding the weight for the directed branches “g_{3, 4}” and “g_{4, 3}” connecting the vertices 3 and 4, the absolute values thereof are determined from the acquired principal minor determinants, but the arguments are unknown.

The second Hermitian matrix B corresponding to FIG. 8 is expressed by the following equation.

$$B = ( \begin{matrix}10 & 2 & 0 & 1 \\ 2 & 12 & 1 & 0 \\ 0 & 1 & 14 & 3 {e}^{i {θ}_{34}} \\ 1 & 0 & 3 {e}^{- i {θ}_{34}} & 16\end{matrix} )$$

As shown in the above equation, the Hermitian matrix generation unit 6 sets the arguments of the components corresponding to the spanning tree in the second Hermitian matrix B to 0. Besides, for the component “B₃₄” in the third row and fourth column and the component “B₄₃” in the fourth row and third column, the absolute values thereof are both “3” and the arguments “θ₃₄”, “−θ₃₄” are not determined yet.

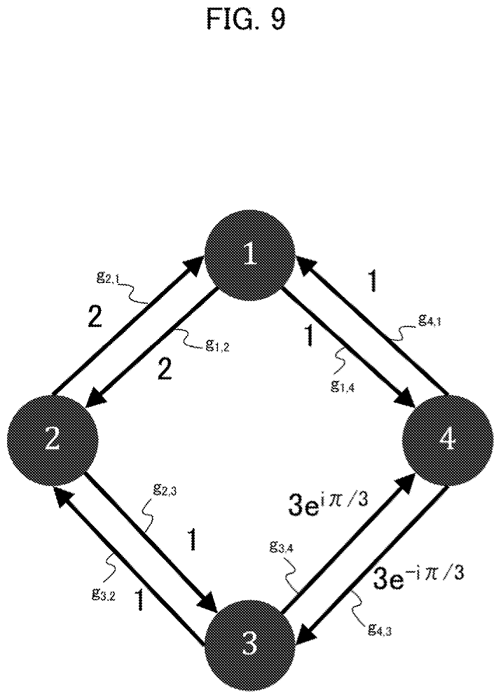

Next, the Hermitian matrix generation unit 6 calculates argument θ₃₄ by executing the directed branch pair adding process for a pair of directed branches g_{3, 4} and g_{4, 3} to be added based on the process at step S15. FIG. 9 illustrates an example of a supplementary graph after executing the process at step S15 for the directed branches g_{3, 4} and g_{4, 3}. Further, the second Hermitian matrix B corresponding to FIG. 9 is expressed by the following equation.

$$B = ( \begin{matrix}10 & 2 & 0 & 1 \\ 2 & 12 & 1 & 0 \\ 0 & 1 & 14 & 3 {e}^{i π / 3} \\ 1 & 0 & 3 {e}^{- i π / 3} & 16\end{matrix} )$$

The second Hermitian matrix B shown in the above equation matches the first Hermitian matrix A with respect to all the principal minor determinants. Thus, the information processing device 1 in the first example embodiment can suitably learn the probability distribution corresponding to the first Hermitian matrix A.

### Second Example Embodiment

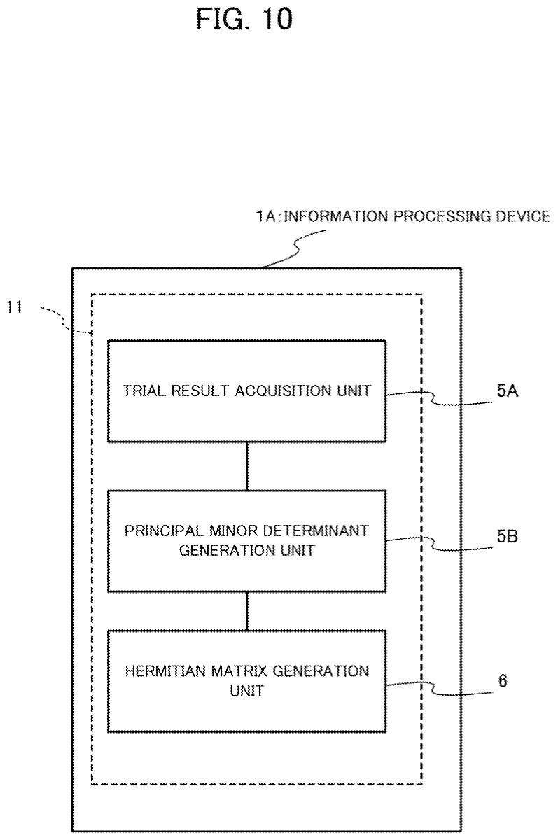

FIG. 10 shows an example of the functional block diagram of the information processing device 1A according to the second example embodiment. The information processing device 1A according to the second example embodiment performs trials of sampling (selecting) a subset B from the set V according to the probability distribution based on the first Hermitian matrix A, and generates the second Hermitian matrix B based on the trial results. Hereafter, the same components as in the first example embodiment are appropriately denoted by the same reference numerals, and a description thereof will be omitted.

The information processing device 1A has the hardware configuration shown in FIG. 4 in the same manner as the information processing device 1 in the first example embodiment. The processor 11 of the information processing device 1A functionally includes a trial result acquisition unit 5A, a principal minor determinant generation unit 5B, and the Hermitian matrix generation unit 6.

The trial result acquisition unit 5A acquires a trial result when a subset S is sampled from the set V according to the probability distribution corresponding to the first Hermitian matrix A. In this instance, the trial result acquisition unit 5A acquires the trial results for a sufficiently large number of times. The “sufficiently large number of times” is set in advance, for example, in consideration of the reliability of the statistic to be calculated based on the obtained trial results, and is stored in advance in the memory 12. The trial result acquisition unit 5A may receive the above-described trial results from a device different from the information processing device 1A, or may acquire the trial results by executing a predetermined application program to recognize the trial result for each trial.

The principal minor determinant generation unit 5B calculates the respective principal minor determinants of the first Hermitian matrix A based on the trial results acquired by the trial result acquisition unit 5A. In the second example embodiment, the matrix representation is different from the matrix representation according to the determinantal point process described in the first example embodiment. The matrix representation according to the determinantal point process in the second example embodiment will be described later.

Based on the principal minor determinants generated by the principal minor determinant generation unit 5B, the Hermitian matrix generation unit 6 generates the second Hermitian matrix B which is consistent with the first Hermitian matrix A with respect to all principal minor determinants. Since the approach for generating the second Hermitian matrix B based on the principal minor determinants is the same as the approach described in the first example embodiment, the description thereof will be omitted.

Next, a description will be given of a matrix representation according to the determinantal point process adopted in the second example embodiment. Hereafter, the matrix representation according to the determinantal point process adopted in the first example embodiment is expressed by “L”, and the matrix representation according to the determinantal point process adopted in the second example embodiment is expressed by “K”. It is also assumed that K and L represent the matrices according to the determinantal point processes in the respective cases.

According to the K representation, the principal minor determinant of the subset S, that is,
det (K (S)) indicates the probability of selecting a set including the subset S from the set V.

On the other hand, according to the L representation, the following expression in which the principal minor determinant of the subset S is normalized
det (L(S))/det (L+I)
   indicates the probability of selecting a set that is exactly the set S from the set V.

Further, the K representation and the L representation are compatible with each other, and each having the relation shown in the following equations.

K=I−(L+I)⁻¹

L=K(I−K)⁻¹

For example, the following two matrices K and L satisfy the relation shown in the above equations with each other and represent the same probability distribution.

$$\begin{matrix}K = ( \begin{matrix}0.5 & 0.3 \\ 0.3 & 0.5\end{matrix} ) \\ L = ( \begin{matrix}2.125 & 1.875 \\ 1.875 & 2.125\end{matrix} )\end{matrix}$$

It is noted that the L representation cannot represent the probability distribution when the probability of selecting an empty set is 0, and that, therefore, strictly speaking, the K representation can represent more various classes of the probability distribution than the L representation. This corresponds to the absence of the inverse of I−K when K indicates such probability distribution that the probability of selecting an empty set is 0 in the above-described equations indicative of the compatibility.

Next, the specific situation according to the second example embodiment will be discussed. An example of a situation suitable for the second example embodiment is analysis of a customer's purchasing tendency. Here, as an example, a purchasing tendency of customers in a store in which the product a and the product b are arranged is considered.

In this case, the subset S is set to any one of:
Nothing is purchased (i.e., S is an empty set);
Purchase of product a (i.e., S={a});
Purchase of product b (i.e., S={b}); and
Purchase of products a and b (i.e., S={a, b}).

In this instance, the trial result acquisition unit 5A acquires the customer action history indicating the presence or absence of purchase and the purchased product(s) for each of the customers who visited the store. For example, the trial result acquisition unit 5A recognizes the number of customers who have entered the store based on the images generated by camera(s) installed in the store, and generates the above-mentioned customer action history with reference to received product purchasing history generated by an account terminal in the store The customer action history may be generated by a device other than the information processing device 1A. In this instance, the trial result acquisition unit 5A receives the generated customer action history from the above-described device.

Then, the principal minor determinant generation unit 5B calculates the estimated principal minor determinant by calculating the probability (ratio) of appearance of each subset based on the customer action history acquired by the trial result acquisition unit 5A. In this instance, the principal minor determinant generation unit 5B calculates the probability of selecting a set including the subset S corresponding to the principal minor determinant to be calculated based on the above-described definition of the K representation. For example, when the principal minor determinant generation unit 5B calculates an component of the matrix K corresponding to the purchase (S=(a)) of the product a, the principal minor determinant generation unit calculates the sum of the ratio of the number of occurrences of purchase (S=(a)) of the product a to the total number of trials and the ratio of the number of occurrences of the purchase (S=(a, b)) of the product a and the product b to the total number of trials.

Thus, the principal minor determinant generation unit 5B can calculate any principal minor determinant for the first Hermitian matrix A based on the customer action history. Thereafter, in the same way as the information processing device 1 according to the first example embodiment does, the information processing device 1A executes the process according to the flowcharts shown in FIGS. 5 and 6 thereby to suitably calculate the second Hermitian matrix B. In the flowchart shown in FIGS. 5 and 6, the trial result acquisition unit 5A of the information processing device 1A acquires trial results (in the above-described example, the customer action history) on the samplings of the subset S at step S11. Then, the principal minor determinant generation unit 5B calculates 1×1 and 2×2 principal minor determinants based on the trial results acquired by the trial result acquisition unit 5A. In the same way, at step S22 in FIG. 6, the principal minor determinant generation unit 5B calculates the principal minor determinant of interest based on the trial results acquired by the trial result acquisition unit 5A.

As such, according to the second example embodiment, the information processing device 1A can suitably perform the learning of the probability distribution regarding the purchasing tendency of the customers or the like. It is noted that it is possible to learn the probability distribution by applying the second example embodiment to other applications (e.g., any action analysis and event analysis) other than analysis of the customer's purchasing tendency as long as the composition as described with respect to the analysis of the purchasing tendency in the second example embodiment is satisfied.

### Third Example Embodiment

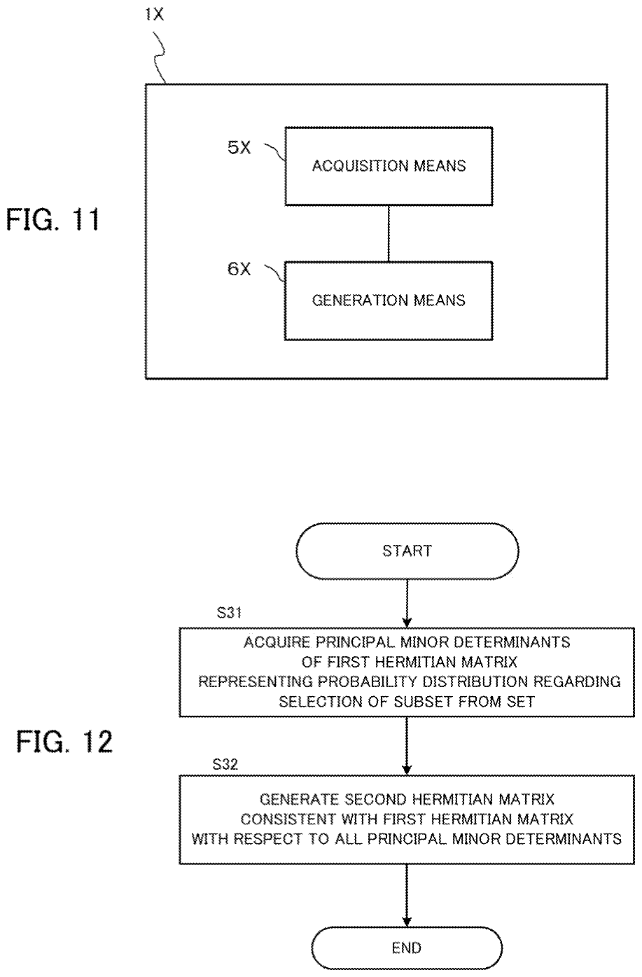

FIG. 11 is a functional block diagram of an information processing device 1X according to a third example embodiment. The information processing device 1X mainly includes an acquisition means 5X and a generation means 6X.

The acquisition means 5X is configured to acquire principal minor determinants of a first Hermitian matrix, the first Hermitian matrix representing a probability distribution regarding selection of a subset from a set of a predetermined number of elements. Examples of the acquisition means 5X include the request unit 5 in the first example embodiment. Examples of the acquisition means 5X also include the principal minor determinant generation unit 5B (and the trial result acquisition unit 5A) in the second example embodiment.

The generation means 6X is configured to generate, based on the principal minor determinants, a second Hermitian matrix which is consistent (matched) with the first Hermitian matrix with respect to (in terms of) all principal minor determinants. Examples of the generation means 6X include the Hermitian matrix generation unit 6 in the first example embodiment or the second example embodiment.

FIG. 12 is an example of a flowchart illustrating a procedure of a process to be executed by the information processing device 1X in the third example embodiment. First, the acquisition means 5X acquires principal minor determinants of a first Hermitian matrix, the first Hermitian matrix representing a probability distribution regarding selection of a subset from a set of a predetermined number of elements (step S31). Next, the generation means 6X generates, based on the principal minor determinants, a second Hermitian matrix which is consistent with the first Hermitian matrix with respect to all principal minor determinants (step S32).

The information processing device 1X according to the third example embodiment can suitably generate a second Hermitian matrix which is consistent, with respect to the principal minor determinants, with the first Hermitian matrix representing the probability distribution regarding selection of a subset from a set of a predetermined number of elements.

In the example embodiments described above, the program is stored by any type of a non-transitory computer-readable medium (non-transitory computer readable medium) and can be supplied to a processor or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments described above can be described as, but not limited to, the following Supplementary Notes.

[Supplementary Note 1]

An information processing device comprising:
is an acquisition means configured to acquire principal minor determinants of a first Hermitian matrix, the first Hermitian matrix representing a probability distribution regarding selection of a subset from a set of a predetermined number of elements; and
a generation means configured to generate, based on the principal minor determinants, a second Hermitian matrix which is consistent with the first Hermitian matrix with respect to all principal minor determinants.

[Supplementary Note 2]

The information processing device according to Supplementary Note 1,
wherein the first Hermitian matrix and the second Hermitian matrix each is a matrix according to a determinantal point process, and
wherein the probability distribution corresponding to the first Hermitian matrix is equal to the probability distribution corresponding to the second Hermitian matrix.

[Supplementary Note 3]

The information processing device according to Supplementary Note 1 or 2,
wherein the generation means is configured to
   generate a supplementary graph in which the respective elements are set to be vertices and a pair of the vertices corresponding to a non-zero component of the second Hermitian matrix are connected by a pair of directed branches, and
   calculate a weight for the pair of the directed branches as the component of the second Hermitian matrix.

[Supplementary Note 4]

The information processing device according to Supplementary Note 3,
wherein the generation means is configured to
   form a spanning tree in which the weight is a real number in the supplementary graph, based on respective 1×1 and 2×2 principal minor determinants of the first Hermitian matrix, and
   calculate the weight for the pair of the directed branches which correspond to the non-zero component and which are not included in the spanning tree, based on the principal minor determinant corresponding to a vertex set of a directed cycle formed by the spanning tree and the pair of the directed branches.

[Supplementary Note 5]

The information processing device according to any one of Supplementary Notes 1 to 4,
wherein an argument of at least a part of components in the second Hermitian matrix is an angle other than a multiple of π.

[Supplementary Note 6]

The information processing device according to any one of Supplementary Notes 1 to 5,
wherein the acquisition means is configured to acquire, based on a query specifying the subset, a principal minor determinant corresponding to the specified subset.

[Supplementary Note 7]

The information processing device according to any one of Supplementary Notes 1 to 5,
wherein the acquisition means is configured to calculate the principal minor determinants based on trial results on the selection of the subset.

[Supplementary Note 8]

The information processing device according to Supplementary Note 7,
wherein, based on the trial results, the acquisition means is configured to calculate, as a principal minor determinant corresponding to a certain subset of the set, a probability that a set including the certain subset is selected.

[Supplementary Note 9]

A control method executed by a computer, the control method comprising:
acquiring principal minor determinants of a first Hermitian matrix, the first Hermitian matrix representing a probability distribution regarding selection of a subset from a set of a predetermined number of elements; and
generating, based on the principal minor determinants, a second Hermitian matrix which is consistent with the first Hermitian matrix with respect to all principal minor determinants.

[Supplementary Note 10]

A storage medium storing a program executed by a computer, the program causing the computer to:
acquire principal minor determinants of a first Hermitian matrix, the first Hermitian matrix representing a probability distribution regarding selection of a subset from a set of a predetermined number of elements; and
generate, based on the principal minor determinants, a second Hermitian matrix which is consistent with the first Hermitian matrix with respect to all principal minor determinants.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All patent and Non-Patent Literatures mentioned in this specification are incorporated by reference in its entirety.

### DESCRIPTION OF REFERENCE NUMERALS

1, 1A, 1X Information processing device
2 Principal minor determinant output device
5 Request unit
5A Trial result acquisition unit
5B Principal minor determinant generation unit
6 Hermitian matrix generation unit
11 Processor
12 Memory
13 Interface
100 Learning system

What is claimed is:

1. An information processing device comprising:
at least one memory configured to store instructions; and
at least one processor configured to execute the instructions to:
acquire principal minor determinants of a first Hermitian matrix, the first Hermitian matrix representing a probability distribution regarding selection of a subset from a set of a predetermined number of elements; and
generate, based on the principal minor determinants, a second Hermitian matrix which is consistent with the first Hermitian matrix with respect to all principal minor determinants.

2. The information processing device according to claim 1,
wherein the first Hermitian matrix and the second Hermitian matrix each is a matrix according to a determinantal point process, and
wherein the probability distribution corresponding to the first Hermitian matrix is equal to the probability distribution corresponding to the second Hermitian matrix.

3. The information processing device according to claim 1,
wherein the at least one processor is configured to execute the instructions to
generate a supplementary graph in which the respective elements are set to be vertices and a pair of the vertices corresponding to a non-zero component of the second Hermitian matrix are connected by a pair of directed branches, and
calculate a weight for the pair of the directed branches as the component of the second Hermitian matrix.

4. The information processing device according to claim 3,
wherein the at least one processor is configured to execute the instructions to
form a spanning tree in which the weight is a real number in the supplementary graph, based on respective 1×1 and 2×2 principal minor determinants of the first Hermitian matrix, and
calculate the weight for the pair of the directed branches which correspond to the non-zero component and which are not included in the spanning tree, based on the principal minor determinant corresponding to a vertex set of a directed cycle formed by the spanning tree and the pair of the directed branches.

5. The information processing device according to claim 1,
wherein an argument of at least a part of components in the second Hermitian matrix is an angle other than a multiple of π.

6. The information processing device according to claim 1,
wherein the at least one processor is configured to execute the instructions to acquire, based on a query specifying the subset, a principal minor determinant corresponding to the specified subset.

7. The information processing device according to claim 1,
wherein the at least one processor is configured to execute the instructions to calculate the principal minor determinants based on trial results on the selection of the subset.

8. The information processing device according to claim 7,
wherein, based on the trial results, the at least one processor is configured to execute the instructions to calculate, as a principal minor determinant corresponding to a certain subset of the set, a probability that a set including the certain subset is selected.

9. A control method executed by a computer, the control method comprising:
acquiring principal minor determinants of a first Hermitian matrix, the first Hermitian matrix representing a probability distribution regarding selection of a subset from a set of a predetermined number of elements; and
generating, based on the principal minor determinants, a second Hermitian matrix which is consistent with the first Hermitian matrix with respect to all principal minor determinants.

10. Anon-transitory computer readable storage medium storing a program executed by a computer, the program causing the computer to:
acquire principal minor determinants of a first Hermitian matrix, the first Hermitian matrix representing a probability distribution regarding selection of a subset from a set of a predetermined number of elements; and
generate, based on the principal minor determinants, a second Hermitian matrix which is consistent with the first Hermitian matrix with respect to all principal minor determinants.
